(19) United States
(12) Patent Application Publication
(10) Pub. No.: US 2026/0059456 A1
(43) Pub. Date: Feb. 26, 2026

(54) ANTENNA POWER AMPLIFIER SELECTION

(71) Applicant: Apple Inc., Cupertino, CA (US)

(72) Inventors: Ali Morshedi, Cupertino, CA (US); Drew Mera, San Diego, CA (US); Yi-Fu Lin, Sunnyvale, CA (US); Zhengbo Zhu, San Diego, CA (US)

(73) Assignee: Apple Inc., Cupertino, CA (US)

(21) Appl. No.: 18/810,482

(22) Filed: Aug. 20, 2024

(51) Int. Cl. H04W 52/38

(52) U.S. Cl. CPC H04W 52/38

(57) ABSTRACT

The present application relates to selecting a power amplifier from among a plurality of power amplifiers of a user equipment (UE) for use in transmitting data via an antenna of the UE to a base station. In an example, the UE stores characterization data that indicates the selection of the power amplifier given a requested power output for the uplink transmission and a set of transmission parameters. This set can include any or a combination of the antenna, a radio access technology, a frequency band, and/or a frequency bandwidth. The characterization data can be generated according to an offline characterization process and can be stored as a look-up table in a memory of the UE.

### BACKGROUND

A user equipment (UE) can communicate with a base station, whereby the UE can transmit data to the UE at a target power transmission power. The base station can indicate this target transmission to the UE. The signal carrying the data for the transmission can be amplified by a power amplifier and transmitted by an antenna coupled with the power amplifier.

### BRIEF DESCRIPTION OF THE DRAWINGS

FIG. 1 illustrates a network environment, in accordance with some embodiments.

FIG. 2 illustrates an example of a multi-antenna user equipment (UE), in accordance with some embodiments.

FIG. 3 illustrates an example of multiple power amplifiers coupled to a same antenna of a UE, in accordance with some embodiments.

FIG. 4 illustrates an example of antenna-power amplifier selections, in accordance with some embodiments.

FIG. 5 illustrates an example of a plot showing performances of different antenna-power amplifier selections, in accordance with some embodiments.

FIG. 6 illustrates an example of an environment for characterizing UEs such that antenna-power amplifier selections can be enabled, in accordance with some embodiments.

FIG. 7 illustrates an example of characterization data that enables antenna-power amplifier selections, in accordance with some embodiments.

FIG. 8 illustrates an example of an operational flow/algorithmic structure implemented by a system to characterize a UE, in accordance with some embodiments.

FIG. 9 illustrates an example of an operational flow/algorithmic structure implemented by a UE to select a power amplifier for a data transmission over an antenna, in accordance with some embodiments.

FIG. 10 illustrates an example of an operational flow/algorithmic structure for an antenna-power amplifier selection, in accordance with some embodiments.

FIG. 11 illustrates another example of an operational flow/algorithmic structure for an antenna-power amplifier selection, in accordance with some embodiments.

FIG. 12 illustrates an example of an operational flow/algorithmic structure for UE characterization, in accordance with some embodiments.

FIG. 13 illustrates another example of an operational flow/algorithmic structure that can follow a UE characterization, in accordance with some embodiments.

FIG. 14 illustrates an example of a UE, in accordance with some embodiments.

FIG. 15 illustrates an example of a base station, in accordance with some embodiments.

FIG. 16 illustrates an example of a system, in accordance with some embodiments.

### DETAILED DESCRIPTION

Embodiments of the present disclosure are directed to, among other things, selecting a power amplifier from among a plurality of power amplifiers of a user equipment (UE) for use in transmitting data via an antenna of the UE to a base station. In an example, the UE can include different types and/or different physical arrangements of power amplifiers, where such power amplifiers are coupled with the antenna. The UE can store in its memory characterization data that associates a set of transmission parameters with a threshold and that indicates which one of the plurality of power amplifiers is to be selected given the set of transmission parameters and how the threshold compares with a target power output. The set of transmission parameters can indicate the radio access technology (RAT) to be used in a data transmission, the frequency band of the data transmission, the frequency bandwidth, and/or the transmission antenna (e.g., in case the UE includes multiple antennas). The target power output can be indicated by the base station. Given the RAT, the frequency band, the frequency bandwidth, and/or the transmission antenna, the UE can determine a value of the threshold from the characterization data. This value and the target power output are compared. If the target power output is larger than the value, a first power amplifier is selected (e.g., a peak performance power amplifier that may consumer more electrical current than a more efficient power amplifier). Conversely, if the target power output is smaller than the value, a second power amplifier is selected (e.g., the more efficient power amplifier). The characterization data can indicate which of the two power amplifiers needs to be selected depending on the outcome of the comparison.

In an example, the characterization data can be generated in an offline environment (e.g., in a laboratory environment) by characterizing different devices under test (DUTs). For a set of transmission parameters (including a particular antenna), a system can instruct a DUT to transmit data using a power amplifier coupled with the antenna, where the transmission is set for a particular power output. The electrical current used by the power amplifier is measured. Similar measurements are repeated for the power amplifier-antenna pair at different power outputs, different power amplifier-antenna pairs, different sets of transmission parameters, and different DUTs of the same type (e.g., having the same architecture). The system can collect the measurements per set of transmission parameters. Given such measurements, the system can identify and associate a threshold and an optimal selection of amplifier per antenna with the relevant set of transmission parameters. The system can format the resulting characterization data as a look-up table (LUT) and can send the LUT to a UE. The UE can store the LUT in its memory for runtime use.

The above techniques can provide several technical advantages. For example, given particular conditions, an optimal power amplifier can be selected and used. This selection can optimize the signal transmission and power consumption. To illustrate, when the UE is closer to an edge of a cell and is requested to transmit at a high power output, the peak performance amplifier can be selected and used, thereby allowing the UE to satisfy the request. In comparison, when the UE is closer to a center of the cell and is requested to transmit at a lower power output, the more efficient power amplifier can be selected and used, thereby allowing the UE to reduce its power consumption.

Various embodiments are described herein in connection with a power amplifier selection based on a target power output for a transmission antenna (referred to as target transmission antenna power). In the embodiments, this selection is enabled using a characterization of power amplifier current consumption as a function of transmission antenna powers. As such, the embodiments are described using two control dimensions: the target transmission antenna power and the power amplifier power consumption. However, the embodiments are not limited as such. As far as the first control dimension, a transmission optimization parameter can be set as the target for the power amplifier selection. The transmission optimization parameter can include any or a combination of parameters (in addition or in lieu of the target transmission antenna power) such as power amplifier current consumption, power amplifier voltage level, power amplifier power consumption, power amplifier thermal characteristic (e.g., how much heat was generated by an already selected power amplifier during a time period, and/or an increase to the operational temperature of the power amplifier or the radio frequency front end due to the use of this power amplifier during the time period), power amplifier use time (e.g., the time length of using the already selected amplifier), and/or a user setting (e.g., a user preference related to switching between amplifiers, how often the switching can be performed based on or independent of the previous parameters, and/or the maximum number for the switching). As far as the second control dimension, a characterization parameter set and can include any or a combination of the parameters listed in this paragraph. A combination of an antenna with multiple controllably coupled power amplifiers can be characterized, whereby the characterization parameter is measured as a function of the transmission optimization parameter.

To illustrate, consider the next examples in which power amplifiers are alternated to improve performance at any time. In a first example, the characterization parameter is the heat characteristic. In this example, for a combination of an antenna with two amplifiers, the heat characteristic can be characterized as a function of any optimization parameter (in a similar and equivalent manner to the embodiments described herein below). The characterization enables the definition of one or more thresholds, such that one of the power amplifiers can be found to support performance benefits based on thermal characteristics, whereas the other power amplifier may have different performance benefits based on thermal characteristics. In this case, the resulting characterization data (e.g., organized in a look-up table) can reflect this characterization.

In a second example, the transmission optimization parameter is the target transmission antenna power. The characterization parameter is the user preference. In this example, for a combination of an antenna with two amplifiers, the user preference can be characterized as a function of transmission antenna powers. The characterization enables the definition of one or more thresholds, such that one of the power amplifiers can be found to be user preferred for transmission antenna power outputs larger than a threshold, whereas the other power amplifier can be found to be preferred for transmission antenna power outputs smaller than the threshold. In this case, the resulting characterization data (e.g., organized in a look-up table) can reflect this characterization.

In a third example, the transmission optimization parameter is the power amplifier current consumption. In this example, for a combination of an antenna with two amplifiers, the current characteristic can be characterized as a function of amplifier power consumptions (in a similar and equivalent manner to the embodiments described herein below). The characterization enables the definition of one or more thresholds, such that one of the power amplifiers can be found to consume more current, whereas the other power amplifier can be found to consume less current. In this case, the resulting characterization data (e.g., organized in a look-up table) can reflect this characterization.

In the interest of clarity of explanation, various embodiments of the present disclosure are described in connection with a new radio (NR) fifth generation (5G) cellular network. However, the embodiments may not be limited as such and can apply to other types of wireless networks including, for instance, fourth generation (4G) cellular networks, sixth generation (6G) cellular networks, WiFi, Bluetooth or any other radio networks.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processing circuitry” as used herein refers to, is part of, or includes circuitry capable of sequentially and automatically carrying out a sequence of arithmetic or logical operations, or recording, storing, or transferring digital data. The term “processing circuitry” may refer to an application processor, a baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The terms “device” and “user equipment (UE)” as used herein refers to a wired and/or wireless computing device with radio communication capabilities and that may use network resources in a communications network. The terms “device” and “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc.

The term “base station” as used herein refers to a device with radio communication capabilities, that is a network component of a communications network (or, more briefly, a network), and that may be configured as an access node in the communications network. A device's access to the communications network may be managed at least in part by the base station, whereby the UE connects with the base station to access the communications network. Depending on the radio access technology (RAT), the base station can be referred to as a gNodeB (gNB), eNodeB (eNB), access point (AP), etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “system” as used herein refers to any type of interconnected electronic devices, computer devices, or components thereof. Additionally, the term “system” may refer to various components of a computer that are communicatively coupled with one another. Furthermore, the term “system” may refer to multiple computer devices or multiple computing systems that are communicatively coupled with one another and configured to share computing and/or networking resources.

The term “coupled” may mean that two or more elements have an established signaling and/or power relationship with one another directly or indirectly such that a signal can be sent from at least one of the elements to another one of the elements and/or power can be supplied and/or controlled by least one of the elements for another one of the elements.

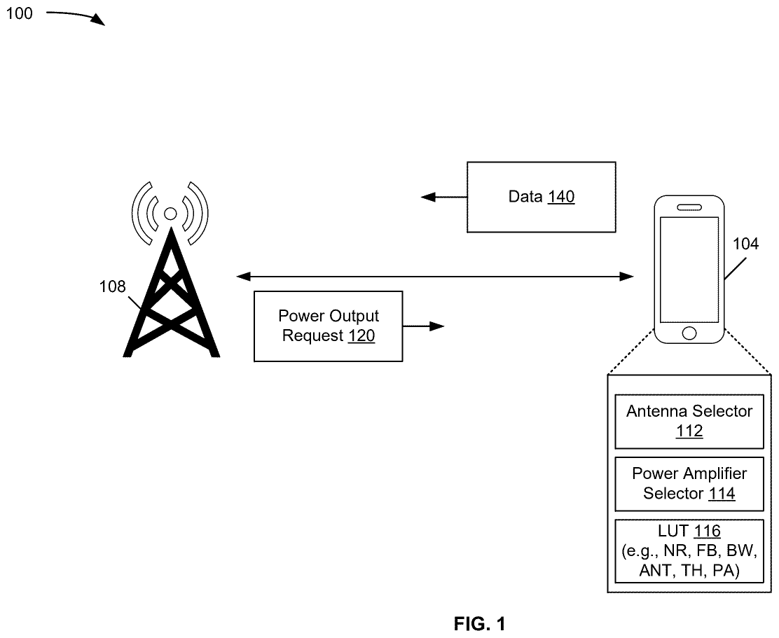

FIG. 1 illustrates a network environment 100, in accordance with some embodiments. As illustrated, the network environment 100 includes a UE 104 and a base station 108. The base station 108 may provide a wireless access cell; for example, a Third-Generation Partnership Project (3GPP) cell (e.g., new radio (NR) 5G cell) through which the UE 104 may communicate with the base station 108. This base station may be a component of a network (e.g., a 3GPP cellular network). The UE 104 and the base station 108 (e.g., a gNB) may communicate over an interface compatible with 3GPP technical specifications.

As further described in the next figures, the UE 104 include one or more antennas. Each antenna can be coupled with multiple power amplifiers. The antenna(s) and power amplifiers can be components of the UE's 104 radio frequency (RF) front end. In the uplink transmission path, a power amplifier can amplify a signal for transmission via an antenna, where the signal carries uplink data.

In the use case of multiple antennas, the UE 104 can implement (in hardware and/or software) an antenna selector 112. The antenna selector 112 can process different inputs among which can be the user grip data and/or reference signal measurements, to select a transmission antenna of the multiple antennas. For example, based on reference signal measurements generates from reception of reference signals by the antennas, a reception antenna is selected (e.g., corresponding to the best reference signal measurement). That same antenna can also be used for transmission. In another example, user grip data can indicate how the UE 104 is being gripped by an end user (e.g., whether it is not gripped at all, gripped with both hands, gripped with one hand, one-hand left grip in portrait mode, one-hand left grip in landscape mode, one-hand right grip in portrait mode, or one-hand right grip in landscape mode). The grip can impact the antenna performance (e.g., whereby the use hand or finger(s) can be located in the RF path of an antenna). The user grip data can be used with other factors (e.g., the reference signal measurements, the frequency band, the frequency bandwidth, and/or radio access technology (RAT) to be used for the transmission) to select the transmission antenna. Example techniques for such antenna selection are described in U.S. Ser. No. 18/796,228, “antenna selection for data transmission and tuner state selection for reception optimization by a multi-antenna user equipment (UE),” filed on Aug. 6, 2024, and U.S. Ser. No. 18/796,166, “artificial intelligence model-based selection of an antenna optimization parameter for a multi-antenna user equipment (UE),” filed on Aug. 6, 2024, the contents of which are incorporated herein by reference in their entirety.

As explained above, the UE 104 can include one antenna or multiple antennas. In both cases, the UE 104 can also include multiple power amplifiers. At least one antenna is coupled with two or more power amplifiers. Assume that this antenna is selected for an uplink transmission. The UE 104 can implement (in hardware and/or software) a power amplifier selector 114. The power amplifier selector 114 can process different inputs, among which can a set of transmission parameters and a power output request 120, to select one of the power amplifiers coupled with the antenna for use to amplify the transmission signal. The set of transmission parameters can include the RAT (e.g., NR for a 5G cellular network, LTE for a 4G cellular network, etc.), frequency band (FB), frequency bandwidth (BW), and antenna (ANT) to be used for the uplink transmission. The power output request 120 can be received from the base station 108 (e.g., via radio resource control (RRC) signaling, downlink control information (DCI), or other means) and can indicate a power output for the uplink transmission (e.g., a power headroom). To enable the power amplifier selection, the UE 104 can store in its memory (e.g., a non-volatile memory) data that indicates the power amplifier to be selected given the set of transmission parameter and the power output. The data can be characterization data generated in an offline environment. Given the set of transmission parameters, the data can indicate a threshold (TH) to be used. Depending on the outcome of the comparison of the power output and threshold, the data can indicate the power amplifier to be selected. In an example, the data can be stored as a look-up table (LUT) 116. In this example, the power amplifier selector 114 can look up the LUT 116 by using the set of transmission parameters and can determine the corresponding value of the threshold determined from the look-up. Further, the power amplifier selector 114 can compare the power output to the value of the threshold and, depending on the comparison's outcome, determine from the LUT 116 the power amplifier. The power amplifier selector 114 selects this power amplifier. Processing circuitry of the UE's 104 front end (e.g., a controller) can then control the coupling of the power amplifier with the transmission antenna and the amplification of the transmission signal by the power amplifier. As a result, the UE 104 can transmit data 140 to the base station 108, where this data 140 represents uplink data carried by the transmission signal amplified by the selected power amplifier and sent via the antenna.

The base station 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with primary synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data (e.g., the application data 140), signaling radio bearer (SRB) messages, system information messages (other than, for example, MIB), and paging messages.

The PDCCH may transfer downlink control information (DCI) that is used by a scheduler of the base station 108 to allocate both uplink and downlink resources. The DCI may also be used to provide uplink power control commands, configure a slot format, or indicate that preemption has occurred.

The base station 108 may also transmit various reference signals to the UE 104. The reference signals may include demodulation reference signals (DM-RSs) for the PBCH, PDCCH, and PDSCH. The UE 104 may compare a received version of the DMRS with a known DM-RS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

The UE 104 may transmit data and control information to the base station 108 using physical uplink channels. Different types of physical uplink channels are possible, including a physical uplink control channel (PUCCH) and a physical uplink shared channel (PUSCH). Whereas the PUCCH carries control information from the UE 104 to the base station 108, such as uplink control information (UCI), the PUSCH carries data traffic (e.g., end-user application data) and can carry UCI.

In an example, communications with the base station 108 can use channels in the frequency range 1 (FR1) band and/or frequency range 2 (FR2) band, although other frequency ranges are possible. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

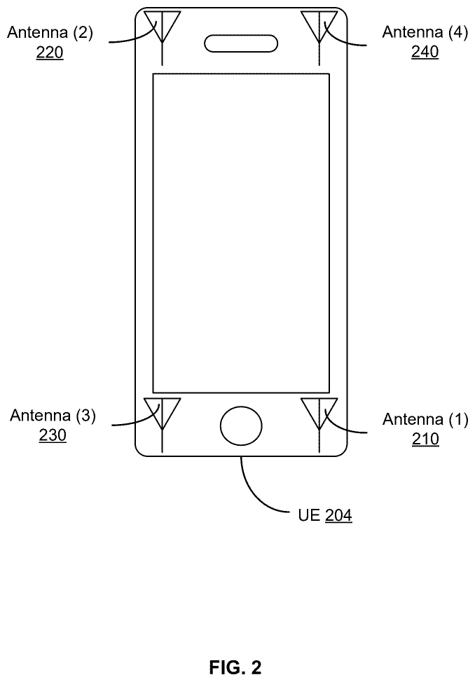

FIG. 2 illustrates an example of a multi-antenna UE 204, in accordance with some embodiments. The multi-antenna UE 204 is an example of the UE 104 of FIG. 1. In the interest of brevity, a multi-antenna UE can be referred to as a UE in the present disclosure. As illustrated, the UE 204 includes four antennas. A first antenna (1) 210 is at the bottom right corner of the UE 204, whereas a second antenna (2) 220 is at the top left corner of the UE 204. Further, a third antenna (3) 230 is at the bottom left corner of the UE 204, whereas a fourth antenna (4) 240 is at the top right corner of the UE 204. Of course, a different number and/or arrangement of antennas is possible dependently on the type and/or model of the UE 204 (e.g., a smartphone, a tablet, a wearable device, and/or a particular model of such devices).

The UE 204 can include a housing that defines user facing side (e.g., where a screen is located and is accessible to the user) and an opposing back side. The antennas (1)-(4) 210-240 can disposed within the housing near the back side, where the back side may include one or more radio frequency (RF) transparent windows at least at the antenna locations. The RF transparency can be impacted by how the UE 204 is gripped by an end user.

Each one of the antennas (1)-(4) 210-240 can be used for reception and/or transmission (e.g., can be a transmit and receive antenna). Further, one or more of the one of the antennas (1)-(4) 210-240 can include multiple antenna elements (e.g., can be an antenna panel that supports beamforming). The antennas (1)-(4) 210-240 can be components of an RF front end of the UE 204. This RF front end can support FDD and/or TDD technologies. As further described herein below, the RF front end can include multiple power amplifiers. At least two of such power amplifiers can be controllably coupled with at least one of the antennas (1)-(4) 210-240.

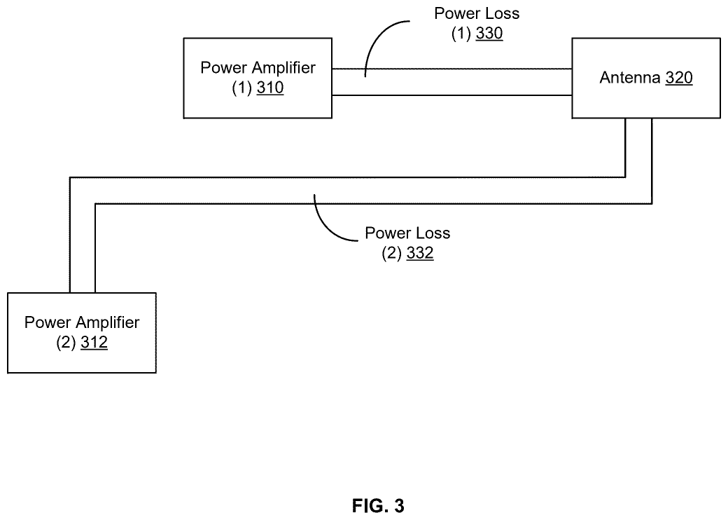

FIG. 3 illustrates an example of multiple power amplifiers coupled to a same antenna of a UE, in accordance with some embodiments. Although a single antenna 320 is shown, the UE can be a multi-antenna UE, such as the UE 204 of FIG. 2. In this case, one or more of the antennas can be each controllably coupled to multiple power amplifiers.

As shown, the UE includes a first power amplifier (1) 310, a second power amplifier (2) 312, and an antenna 320 (although a larger number of power amplifiers and/or antennas is possible). Each of the two power amplifiers 310 and 312 is coupled with the antenna 320. The coupling allows each of the power amplifiers 310 and 312 to amplify a signal to be transmitted by the antenna 320. For example, the coupling can be an electrical coupling that involves electrically conductive material arranged to create an electrical path between each power amplifiers 310 and 312 and the antenna 320 (e.g., as vias on a board where the power amplifiers 310 and 312 and the antenna 320 are installed, as wires, etc.). The coupling can also be controlled such that only one the two electrical paths is conductive at a time (e.g., via a controller and a set of switches installed on the board, where the controller can change the state of the switches such that, at any point in time, only the electrical path between the first power amplifier (1) 310 and the antenna 320 is closed and conductive while the electrical path between the second power amplifier (2) 312 and the antenna 320 is open or vice versa).

In an example, the first power amplifier (1) 310, the second power amplifier (2) 312, and the antenna 320 are arranged at different locations in the UE (possibly on a same board). As illustrated, the first power amplifier (1) 310 is physically closer than the second power amplifier (2) 312 to the antenna 320. Because it is physically closer, the electrical path between the first power amplifier (1) 310 and the antenna 320 can be less resistive than the electrical path between the second power amplifier (2) 312 and the antenna 320 (assuming the same conductive material is used to create these electrical paths). As such, a first power loss (1) 330 between the first power amplifier (1) 310 and the antenna 320 (e.g., due to the lower resistivity of the corresponding electrical path) is smaller than a second power loss (2) 332 between the second power amplifier (2) 312 and the antenna 320 (e.g., due to the higher resistivity of the corresponding electrical path). As such, to achieve the same signal amplification at the antenna 320, the second power amplifier (2) 312 needs to consume more power (e.g., more current, assuming that the two power amplifiers 310 and 312 are supplied the same guardrail voltage). In other words, given the closer proximity of the first power amplifier (1) 310 to the antenna 320, the first power amplifier (1) 310 is more power efficient (e.g., consumes less current) than the second power amplifier (2) 312 relative to the antenna 320.

The first power amplifier (1) 310 and the second power amplifier (2) 312 may have the same electrical characteristics (e.g., the same power consumption and signal amplification by, for example, being of the same model). In this case, the different power losses can impact the signal amplification capabilities. In particular, say a particular a power output of the antenna 320 is desired. The amplification of the second power amplifier (2) 312 is less efficient than that of the first power amplifier (1) 310. Furthermore, the amplification of the second power amplifier (2) may be capped or clipped due to the higher power loss (2) 332. To illustrate, assume the maximum amplification is 20 dBm of each of the two power amplifier 310 and 312, the power loss (1) is 1 dBm, and the power loss (2) is 3 dBm. As such, the actual maximum amplification of the first power amplifier (1) 310 is 19 dBm, while that of the second power amplifier (2) 312 is 17 dBm. If the desired output power of the antenna is 18 dBm, the first power amplifier (1) 310 may be capable of supporting it, whereas the second power amplifier (2) 312 may not because of its higher power loss (2) 332.

It is possible though that the first power amplifier (1) 310 and the second power amplifier (2) 312 have the different electrical characteristics (e.g., different power consumptions and/or different signal amplifications by, for example, being of different models). In this case, the first power amplifier (1) 310 and the second power amplifier (2) 312 may still be at different distances from the antenna 320 (and, thus, have different power losses) or may be at equal distances from the antenna 320 (and, thus, the same power loss). The power loss(es) and/or different electrical characteristics can impact the power efficiency and/or power transmission headroom of the signal transmission.

As further described in the next figures, the different power losses and/or the different electrical characteristics can be accounted for in selecting the power amplifier from the first power amplifier (1) 310 and the second power amplifier (2) 312 to use for amplifying a signal to be transmitted via the antenna 320. Generally, when needed to achieve a high output power of the antenna 320 (where high can be defined as being larger than a threshold), the less power efficient power and more signal amplification capable power amplifier can be selected. This high power need can correspond to the case when the UE is at an edge of a cell (e.g., at a large distance away from the base station 108). In comparison, when needed to achieve a low output power of the antenna 320 (where low can be defined as being smaller than the threshold), the more power efficient power and possibly less signal amplification capable power amplifier can be selected. This low power need can correspond to the case when the UE is not at the edge of the cell (e.g., at a close distance to the base station 108). Which of the first power amplifier (1) 310 and the second power amplifier (2) can be considered more more/less power efficient power and more/less signal amplification capable (e.g., in a combination with the antenna 320) can be determined via a device characterization process.

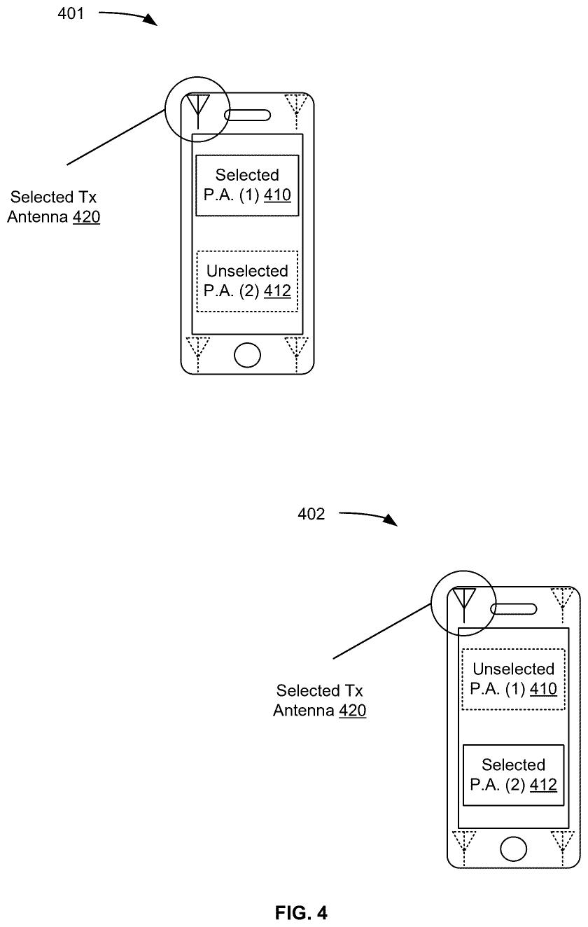

FIG. 4 illustrates an example of antenna-power amplifier selections, in accordance with some embodiments. In an example, a UE (e.g., the UE 204 of FIG. 2) includes four antennas and at least a first power amplifier (1) 410 and a second power amplifier (2) 412 (similar to the first power amplifier (1) 310 and the second power amplifier (2) 312). One of the first antennas is selected as a transmission antenna 420 (shown with solid lines as the top left antennas, whereas the remaining three antennas are shown with dotted lines). This selection can be based on different factors including, for instance, user grip data and/or reference signal measurements.

Given other factors (e.g., a requested power output given a proximity of the UE to a base station), the UE performs a first power amplifier selection 401. According to this power amplifier selection 401, the first power amplifier (1) 410 is selected rather than the second power amplifier (2) 420 (this selection is shown by using a solid rectangle for the first power amplifier (1) 410 and a dotted rectangle for the second power amplifier (2) 412). The electrical path between the first power amplifier (1) 410 and the transmission antenna 420 is closed, whereas the electrical path between the second power amplifier (2) 412 and the transmission antenna 420 is open. The signal is amplified by the first power amplifier (1) 410 and transmitted by the transmission antenna 420.

Update to the factors can occur (e.g., a lower or higher power output is requested given a different proximity of the UE to the base station). The UE can then perform a second power amplifier selection 402. According to this power amplifier selection 402, the first power amplifier (1) 410 is deselected and the second power amplifier (2) 420 is selected (this selection is shown by using a totted rectangle for the first power amplifier (1) 410 and a solid rectangle for the second power amplifier (2) 412). The electrical path between the first power amplifier (1) 410 and the transmission antenna 420 is open, whereas the electrical path between the second power amplifier (2) 412 and the transmission antenna 420 is closed. The signal is amplified by the second power amplifier (2) 412 and transmitted by the transmission antenna 420.

In FIGS. 2 and 4, four antennas are shown. In FIGS. 3 and 4, two power amplifiers coupled to an antenna are shown. The embodiments are not limited as such. Generally, a UE can include N antennas and M power amplifiers. Each antenna can be controllably coupled to one or more of the M power amplifiers. At one of the antenna is controllably coupled to two or more power amplifiers. The number of power amplifiers per antenna can vary depending on the antenna.

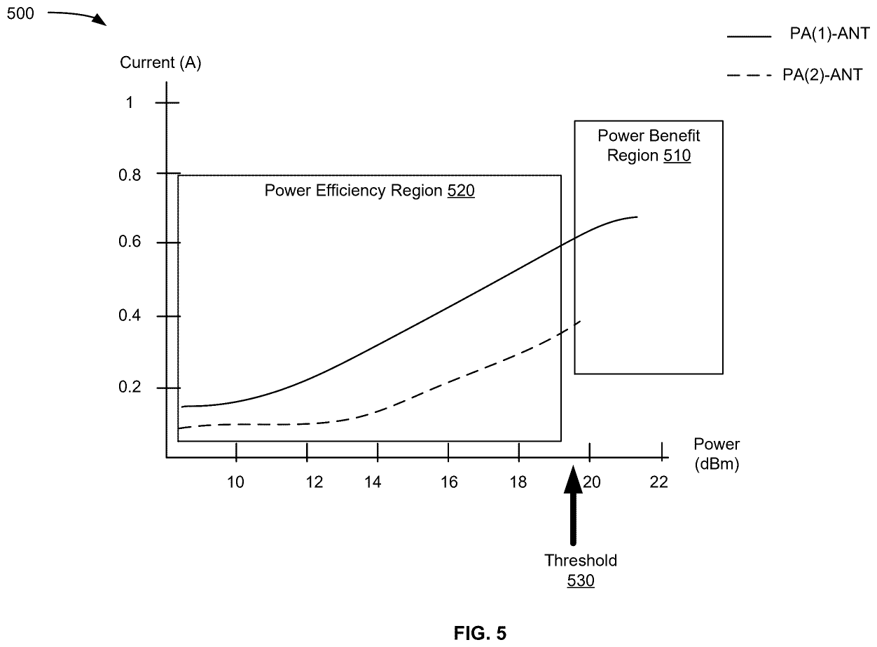

FIG. 5 illustrates an example of a plot 500 showing performances of different antenna-power amplifier selections, in accordance with some embodiments. The plot 500 can be generated by using a device characterization process (further described herein below) and can help identifying a value for a threshold 530 to use given a set of transmission parameters and a power output. At runtime, given a set of transmission parameters, the value of the threshold 530 can determined and compared with a power output to select the most optimal power amplifier.

The horizonal axis of the plot 500 represents the power output of an antenna in dBm. The vertical axis of the plot 500 represents the current consumption of a power amplifier in amperemeters (or, more generally, its power consumption). The plot 500 includes two curves: a first curve (shown with a solid line) that shows the current consumption of a first power amplifier (e.g., the first power amplifier (1) 310) as a function of the power output of the antenna (e.g., the antenna 320), and a second curve (shown with a dashed line) that shows the current consumption of a second power amplifier (e.g., the second power amplifier (2) 312) as a function of the power output of the antenna. The two amplifiers can be controllably coupled with the antenna. Each curve corresponds to a selected combination of power amplifier and antenna (e.g., to one of the two selections 401 or 402 of FIG. 4).

In the illustration of FIG. 5, relative to the second power amplifier, the first power amplifier has generally a higher power consumption for the same antenna's power output and can contribute to a higher signal amplification (e.g., unlike the second power amplifier, its contribution is not capped at 20 dBm and can extend to about 22 dBm). Conversely, relative to the first power amplifier, the second power amplifier has generally a lower power consumption for the same antenna's power output but may be incapable of contributing to a higher signal amplification (e.g., unlike the first power amplifier, its contribution is capped at about 20 dBm).

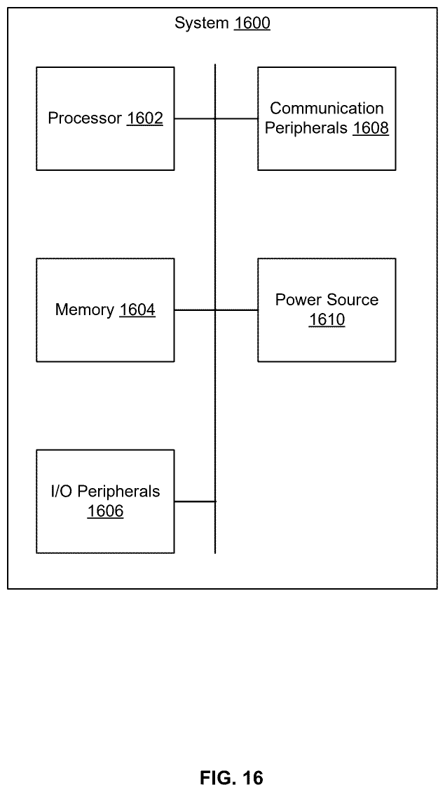

The capping corresponds to a point on the horizontal axis after which the more efficient power amplifier (e.g., the second power amplifier in this case) becomes incapable of supporting the desired power output of the antenna. This capping point can also be referred to as a switch point and is used to define a value of the threshold 530. For instance, the value can be set to be equal or within a range (e.g., plus/minus ten percent) of the capping point. In the illustration of FIG. 16, the value can be set to be 19.5 dBm as an example.

In an example, the threshold 530 allows defining two regions: a power benefit region 510 (for any power output larger than the value of the threshold 530) and a power efficiency region 520 (for any power output smaller than the value of the threshold 530). Each of the two regions 510 can be associated with a selection of one of the two power amplifiers. In the illustration of FIG. 5, the power benefit region 510 is associated with the first power amplifier (that is relatively less power efficient but more signal amplification capable). In comparison, the power efficient region 520 is associated with the second power amplifier (that is relatively more power efficient, while being as signal amplification capable as the first power amplifier in this region 520).

If the UE selects the antenna and is requested to use a particular power output, this power output can be compared to the value of the threshold 530. If the outcome of the comparison indicates that the power output is larger than the threshold's 530 value (e.g., falls in the power benefit region 510), the power amplifier associated with the power benefit region 510 is selected (e.g., the first power amplifier). If the outcome indicates that the power output is smaller than the threshold's 530 value (e.g., falls in the power efficiency region 520), the power amplifier associated with the power efficiency region 520 is selected (e.g., the second power amplifier).

Although the plot 500 illustrates only two curves and two regions (e.g., defined by a single threshold), a different number of curves and/or regions can be used. For example, the number of curves can depend on the number of power amplifiers that can be controllably coupled with the antenna (e.g., can be the same number). The number of regions can depend on a desired granularity for the power outputs and current consumptions in the control. For instance, at low current consumption (say less than 0.2 A), it may be acceptable to select the less power efficient amplifier. In this case, a second threshold can be defined at about 11 dBm, such that the power efficiency region 520 is split in two regions (one for power outputs less than 11 dBm and associated with the first power amplifier, and one for power outputs between 11 dBm and 19.5 dBm and associated with the second power amplifier).

The plot 500 describes the characterization of one particular characterization parameter (e.g., current consumption) as a function of one particular transmission optimization parameter (e.g., power output). However, the embodiments are not limited as such and can similarly apply to other types of characterization parameters and/or other transmission optimization parameters. Such other types of parameters are described herein above. One or more characterization parameters can be defined as a function of or modeled using one or more transmission optimization parameters.

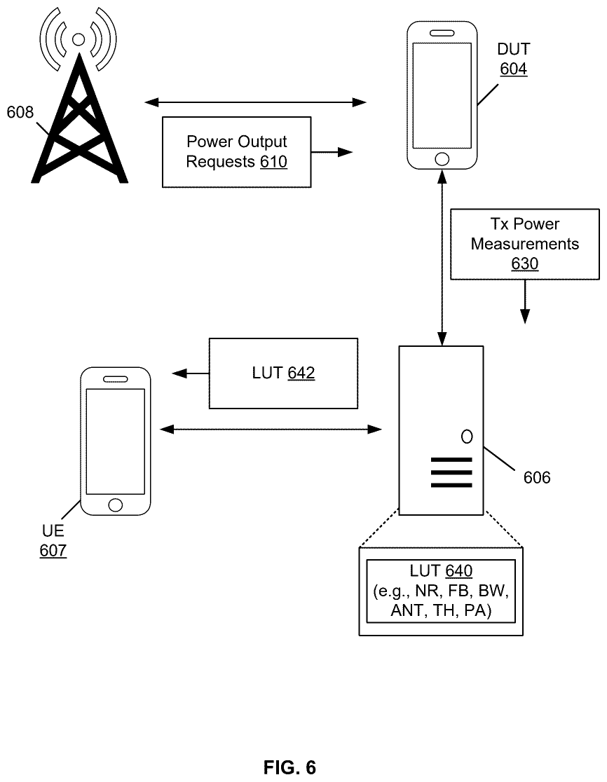

FIG. 6 illustrates an example of an environment for characterizing UEs such that antenna-power amplifier selections can be enabled, in accordance with some embodiments. The UEs can be DUTs that are of a same type (e.g., the type corresponding to the UE 204) and that are subject to a device characterization process. Once this process is completed, a UE of that type (e.g. the UE 204) can use the resulting characterization data in its selection of a power amplifier to use for a transmission via an antenna. The device characterization process can collect transmission power measurements for different sets of transmission parameters (e.g., antenna power outputs and amplifier current consumptions) from which thresholds can be determined. Referring to FIG. 5, the figure shows one particular illustration of transmission power measurements for a combination of two power amplifiers with an antenna and for one set of power transmission parameters, from which a single threshold is defined. Similar characterizations can be performed across multiple DUTs, sets of transmission parameters, and/or power amplifier-antenna combinations. As described herein above, the characterization need not be limited to current consumption and power output but can be similarly and equivalently apply to one or more characterization parameters and one or more transmission optimization parameters.

The environment can correspond to an offline environment (e.g., a laboratory or testing environment) that includes a system 606 and a base station 608. The base station 608 may, but need not, be a component of the system 606. The system 606 can include among other things, computing resources (e.g., servers, cloud based compute resources, etc.) and test equipment (e.g., power meters, power analyzers, network analyzers, etc.). The base station 608 can, but need not, operate under the control of the system 606 (e.g., the system 606 can instruct the base station 608 to send power output requests 610, each indicated a power output for a transmission via an antenna). A DUT 604 can be subject to testing as part of the device characterization process.

Given a RAT, frequency band, and frequency bandwidth, the base station 608 can send a power output request to the DUT 604. In turn, the DUT 604 can select (e.g., under the control of the system 606 or independently thereof) an antenna and a power amplifier for a transmission at the requested power output. Test equipment of the system 606 coupled to the DUT 604 can measure the power consumption (e.g., current consumption) of the power amplifier needed to achieve the requested power output and, optionally, the actual power output of the antenna. As such, the system 606 can collect the power consumption, the requested power output and, optionally, the actual power output for a selected antenna and a selected power amplifier and for the particular RAT, frequency band, and frequency bandwidth. This measurement information can be collected as part of transmission power measurements 630. The transmission power measurements 630 can include similar measurement information (specifically, the corresponding antenna, power amplifier, RAT, frequency band, frequency bandwidth, power consumption, requested power output, and possibly actual power output) derived for different antennas, power amplifiers, RATs, frequency bands, frequency bandwidths, power consumptions, requested power outputs, and DUTs of the same type.

The system 606 can execute a set of application and/or algorithms to generate characterization data from the transmission power measurements 630. For example, for a set of transmission parameters (e.g., the same RAT, the same frequency band, the same frequency bandwidth, the same antenna on the DUT 604 and corresponding same antennas on the other DUTs, and the same power amplifier on the DUT 604 and corresponding same power amplifiers on the other DUTs), the system 606 can determine the measured power consumptions (e.g., current consumptions) per power output (requested or measured). A statistical measure (e.g., average, median, etc.) can be applied thereto to generate a power consumption per power output for that set of transmission parameters. This processing can be repeated to determine, for that same set of transmission parameters, the power consumptions across the different power outputs. The maximum power output can be set as the capping point for the power amplifier given the other transmission parameters, and the corresponding power consumptions can be noted. This processing can be repeated for different sets of transmission parameters, thereby enabling the definition of regions and thresholds across the different sets of transmission parameters. Particularly, for the same antenna, RAT, frequency band, and frequency bandwidth, and for two or more different power amplifiers, the corresponding power consumptions and power outputs (including capping points) can be compared to define regions, thereby enabling the definition of threshold(s) that are then associated the two or more amplifiers and with the antenna, RAT, frequency band, and frequency bandwidth.

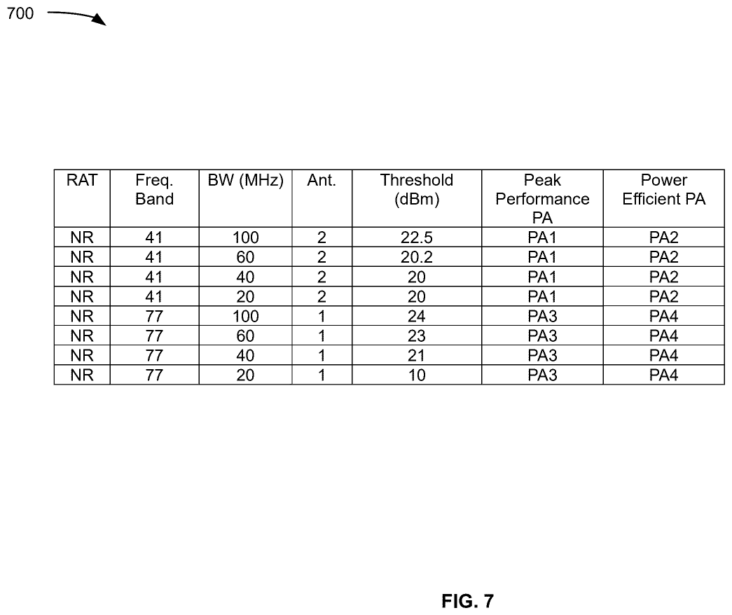

The output of the processing can include characterization data. For a set of transmission parameters that includes one or more of the RAT, the antenna, the frequency band, and the frequency bandwidth to use for transmission, the characterization data can indicate a value of a threshold to use and which power amplifier to use depending on how a requested power output compares to the value (e.g., is larger or smaller than the value). The system 606 can organize the characterization data in a LUT 640. An example of this LUT 640 is further shown in FIG. 7.

For a UE 607 of the same type as the DUTs, a copy of the LUT 640 (shown as a LUT 642) can be stored by the UE 607 for runtime use. This LUT 642 can be sent over the air (OTA) or can be stored in memory as part of the UE's 607 manufacturing or provisioning.

FIG. 7 illustrates an example of characterization data that enables antenna-power amplifier selections, in accordance with some embodiments. The characterization data can be organized in a LUT 700 that includes multiple fields in a column arrangement. These fields identify a RAT, a frequency band, a frequency bandwidth (e.g., in MHz), an antenna, a threshold (e.g., a dBM), a peak performance power amplifier, and a power efficient power amplifier. Each entry (e.g., an intersection of a row with a column) stores the value for a field corresponding to the column.

The RAT, frequency band, frequency bandwidth, and antenna can represent a set of transmission parameters that can be used to look up a value for the threshold. Depending on a comparison of this value with a requested power output, either the power amplifier identified in the peak performance power amplifier field or the power efficient power amplifier field is selected.

To illustrate, consider that a UE storing the LUT 700 needs to transmit data using NR as the RAT, n41 as the frequency bandwidth, and 40 MHz as the bandwidth. Also consider that the UE selected antenna “2” for this transmission. The UE can form a set of transmission parameters with values of {NR, n41, 40, 2} and look up the LUT 700. The look-up result indicates that the value of the threshold is 20 dBm and that, if a requested power output exceeds this value, then a first power amplifier is to be used (this power amplifier being less power efficient but more signal amplification capable), and otherwise a second power amplifier is to be used (e.g., this power amplifier being more power efficient but less signal amplification capable). If a base station requests a power output of more than 20 dBm (or the UE measures its actual power output at antenna “2” and determines it is larger than 20 dBm), then the UE selects the first power amplifier for the transmission. If the base station requests a power output of less than 20 dBm (or the UE measures its actual power output at antenna “2” and determines it is smaller than 20 dBm), then the UE selects the second power amplifier for the transmission.

In another example, the UE can default to using the less power efficient but more signal amplification capable power amplifier. The UE can perform the LUT look-up and can switch to using the more power efficient but less signal amplification capable amplifier only when the threshold-power output comparison indicates that the value of the threshold is smaller. Referring back to {NR, n41, 40, 2}, by default the UE uses the first power amplifier without the need to compare the power output with the 20 dBm threshold. However, once the comparison is performed, if the power output is larger than 20 dBm, the UE continues using the first power amplifier. Otherwise, the UE switches to using the second power amplifier.

The LUT 700 is provided for illustrative purposes only. It can identify other RATs, frequency bands, antennas, thresholds, and/or power amplifiers. Generally, only certain frequency bands may be subject to the power amplifier selection and, thus, the LUT 700 need not be defined for all frequency bands. For a same frequency band and antenna, the threshold and/or power amplifier selection can vary depending on the bandwidth and/or antenna. In the illustration of FIG. 7, for {NR, n41, 2}, the threshold is 22.5 dBm for a 100 MHz bandwidth and 20.5 dBm for a 60 MHz bandwidth. Similarly, for different frequency bands (and possibly the same or different antenna), the threshold and/or power amplifier selection can vary. In other words, for two different values of the same transmission parameter (e.g., NR and LTE, n41 and n77, 100 MHz and 60 MHz antenna (1) and antenna (2), etc.), the value of the threshold and/or the power amplifier selection can vary depending on the values of the other transmission parameters.

The LUT 700 is described in connection with transmission parameters (e.g., RAT, frequency band, frequency bandwidth, and antenna), a threshold, and power amplifiers selected for a target power output in given power amplifier current consumption. As described herein above, the current consumption is one example of a characterization parameter, whereas the target power output is one example of a transmission optimization parameter. The embodiments are not limited as such. Instead, the LUT 700 can be defined similarly for one or more characterization parameters and one or more transmission optimization parameters. For example, for heat characteristics as a characterization parameter and target power output as a transmission optimization parameter, the same transmission parameters can be found in a LUT, in addition to a threshold, and an identification of which power amplifier to select depending on how the threshold compares to a target power output, where this selection is based on the heat characteristics. In another example, for a user preference as a characterization parameter and target power output as a transmission optimization parameter, the same transmission parameters can be found in a LUT, in addition to a threshold, and an identification of which power amplifier to select depending on how the threshold compares to a target power output, where this selection is based on the user preference.

Further, the LUT 700 is one example data structure for organizing the characterization data. Other data structures are possible. Regardless of the implemented data structure a UE can use the characterization data to determine in real-time the power amplifier to select.

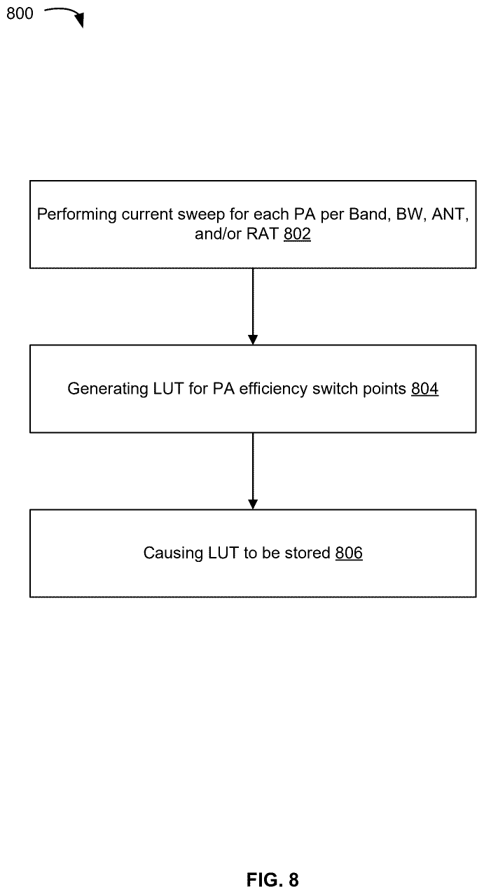

FIG. 8 illustrates an example of an operational flow/algorithmic structure implemented 800 by a system (or an apparatus of the system, where the apparatus includes processing circuitry) to characterize a UE, in accordance with some embodiments. The system can be an example of the system 606 of FIG. 6. The UE can be a DUT. In some embodiments, the operational flow/algorithmic structure 800 may be implemented by executing instructions stored in a tangible, non-transitory, computer-readable storage medium, such as a memory of the system. While the operational flow/algorithmic structure 800 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 800 includes, at 802, performing a current sweep for each power amplifier of the UE, where the current sweep is performed per frequency band, frequency bandwidth, antenna, and/or RAT. For instance, the system can include or instruct a base station to request a particular power output for a transmission by the UE. The transmission can use a particular RAT, frequency band, frequency bandwidth, and antenna. Given a power amplifier used for the transmission, the system can measure or receive transmission power measurements indicating the current consumption of the power amplifier, the requested power output, and, optionally, the actual power output of the antenna. Such transmission power measurements can be repeated and collected per frequency band, frequency bandwidth, antenna, and/or RAT and can be repeated and collected for different power amplifiers.

In an example, the operational flow/algorithmic structure 800 includes, at 804, generating a LUT for power amplifier efficiency switch points. For instance, and as described in FIG. 6, the transmission power measurements can be processed to determine the switch point and the corresponding current consumption per power amplifier per frequency band, frequency bandwidth, antenna, and/or RAT. Switch points of at least two power amplifiers and per frequency band, frequency bandwidth, antenna, and/or RAT can be compared to define at least one threshold, and the corresponding current consumptions can be compared to determine which power amplifier is more power efficient or not such that the power amplifiers can be associated with the relevant regions defined by the threshold(s). The resulting characterization data can be organized in the LUT, where the LUT can take the arrangement of the LUT 700.

In an example, the operational flow/algorithmic structure 800 includes, at 806 causing the LUT to be stored. For instance, the LUT is sent OTA to a UE post manufacturing or is downloaded to the UE during manufacturing and stored thereat for runtime use.

The operational flow/algorithmic structure 800 is described in connection transmission antenna power outputs and current consumptions in given power amplifier current consumption. As described herein above, the current consumption is one example of a characterization parameter, whereas the target power output is one example of a transmission optimization parameter. The embodiments are not limited as such. Instead, the operational flow/algorithmic structure 800 can be performed similarly for one or more characterization parameters and one or more transmission optimization parameters.

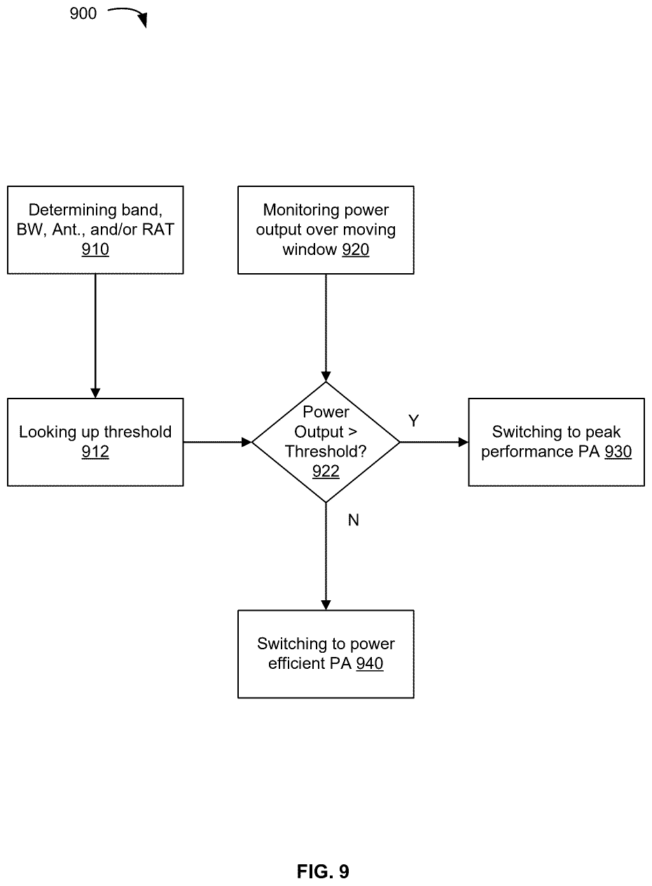

FIG. 9 illustrates an example of an operational flow/algorithmic structure 900 implemented by a UE (or an apparatus of the UE, where the apparatus includes processing circuitry) to select a power amplifier for a data transmission over an antenna, in accordance with some embodiments. The UE can be an example of any of the UEs described herein. In some embodiments, the operational flow/algorithmic structure 900 may be implemented by executing instructions stored in a tangible, non-transitory, computer-readable storage medium, such as a memory of the UE. While the operational flow/algorithmic structure 900 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 900 includes, at 910, determining frequency band, frequency bandwidth, antenna, and/or RAT to use for an uplink transmission. For instance, the frequency band, frequency bandwidth, and/or RAT can be determined from a radio resource control configuration and/or DCI. The antenna can be selected by an antenna selector of the UE as described in FIG. 1.

In an example, the operational flow/algorithmic structure 900 includes, at 912, looking up a threshold. For instance, the values of the frequency band (e.g., its identifier such as “n41”), the frequency bandwidth (e.g., “100 MHz”), the antenna (e.g., its identifier such as “2”), and the RAT (e.g., its identifier such as “NR”) can be used in a look-up of a LUT. The LUT can be stored by the UE and may have been generated according to the operational flow/algorithmic structure 800. The LUT can store a value for the threshold (e.g., “22.5 dBm”) corresponding to the values of the frequency band, frequency bandwidth, and/or RAT. The result of the look-up can include the value and, possibly, an indication of which power amplifier is to be selected when a power output is compared to this value of the threshold.

In an example, the operational flow/algorithmic structure 900 includes, at 920, monitoring a power output over a moving window. The moving window can be a period of time (e.g., 5 milliseconds, 500 milliseconds, etc.) that shifts repeatedly (e.g., every 2.5 milliseconds, 250 milliseconds, etc.) and that is used to determine a statistical measure for the power output (e.g., an average, a median). Doing so can avoid changing the power amplifier selection in case of an instantaneous and ephemeral power output change. The power output can be a requested power output by a base station (e.g., an average or a median of the requested power headroom over the period of time) or an actual power output measured at the antenna (e.g., an average or a median of the measured power headroom over the period of time).

In an example, the operational flow/algorithmic structure 900 includes, at 922, comparing the power output to the threshold. This comparison can be repeated each time the moving window is shifted. The statistical measure (e.g., average or median) is compared to the value of the threshold. If this measure is larger than the value, the operational flow/algorithmic structure 900 can flow to 930. Otherwise, the operational flow/algorithmic structure 900 can flow to 940.

In an example, the operational flow/algorithmic structure 900 includes, at 930, switching to a peak performance power amplifier. For the values of the frequency band (e.g., its identifier such as “n41”), the frequency bandwidth (e.g., “100 MHz”), the antenna (e.g., its identifier such as “2”), and the RAT (e.g., its identifier such as “NR”), the LUT can identify the peak performance power amplifier (e.g., “PA1”) to use when the value of the power output is larger than the value of the threshold. This identifier can be returned as part of the initial look-up result or as part of a result of a second look-up of the LUT. The UE can select this power amplifier (e.g., “PA1”) and controllably couple it with the antenna such that the signal is amplified by the selected power amplifier prior to the transmission.

In an example, the operational flow/algorithmic structure 900 includes, at 940, switching to a power efficient power amplifier. For the values of the frequency band (e.g., its identifier such as “n41”), the frequency bandwidth (e.g., “100 MHz”), the antenna (e.g., its identifier such as “2”), and the RAT (e.g., its identifier such as “NR”), the LUT can identify the power efficient power amplifier (e.g., “PA2”) to use when the value of the power output is smaller than the value of the threshold. This identifier can be returned as part of the initial look-up result or as part of a result of a second look-up of the LUT. The UE can select this power amplifier (e.g., “PA2”) and controllably couple it with the antenna such that the signal is amplified by the selected power amplifier prior to the transmission.

The operational flow/algorithmic structure 900 is described in connection transmission antenna power outputs and current consumptions in given power amplifier current consumption. As described herein above, the current consumption is one example of a characterization parameter, whereas the target power output is one example of a transmission optimization parameter. The embodiments are not limited as such. Instead, the operational flow/algorithmic structure 900 can be performed similarly for one or more characterization parameters and one or more transmission optimization parameters.

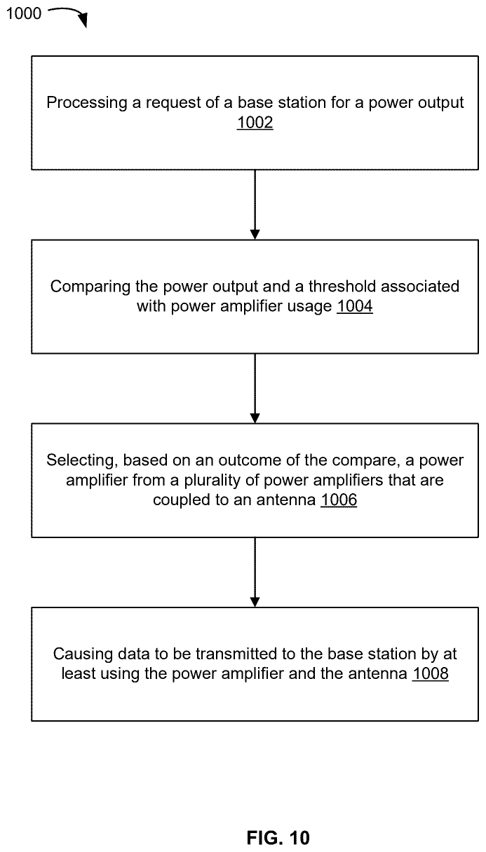

FIG. 10 illustrates an example of an operational flow/algorithmic structure 1000 for an antenna-power amplifier selection, in accordance with some embodiments. The operational flow/algorithmic structure 1000 can be implemented by a UE (or an apparatus of the UE, where the apparatus includes processing circuitry). The UE can be an example of any of the UEs described herein. In some embodiments, the operational flow/algorithmic structure 1000 may be implemented by executing instructions stored in a tangible, non-transitory, computer-readable storage medium, such as a memory of the UE. While the operational flow/algorithmic structure 1000 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1000 includes, at 1002, processing a request of a base station for a power output. For instance, the request is received in DCI and indicates a power headroom for an uplink transmission.

In an example, the operational flow/algorithmic structure 1000 includes, at 1004, comparing the power output and a threshold associated with power amplifier usage. For instance, a moving window can be used to generate a statistical measure (e.g., average or median) of requested power outputs over time. Alternatively, the moving window can be used to generate a statistical measure (e.g., average or median) of measured power outputs over time, where each of such power outputs is measured at an antenna and corresponds to a requested power output. Given a set of transmission parameters associated with an uplink transmission at the requested power output (e.g., RAT, frequency band, frequency bandwidth, and antenna), a LUT (or, more generally, characterization data) can be looked up to determine a value of the threshold. The value of the power output and the value of the threshold can be compared.

In an example, the operational flow/algorithmic structure 1000 includes, at 1006, selecting, based on an outcome of the compare, a power amplifier from a plurality of power amplifiers that are coupled to an antenna. For instance, if the value of the power output is larger than the value of the threshold, a first power amplifier is selected (e.g., a peak performance power amplifier). Otherwise, a second power amplifier is selected (e.g., a power efficient power amplifier). The LUT (or, more generally, the characterization data) can identify which power amplifier is to be selected depending on the outcome of the comparison.

In an example, the operational flow/algorithmic structure 1000 includes, at 1008, causing data to be transmitted to the base station by at least using the power amplifier and the antenna. For instance, a signal that encodes the data is generated by components of an RF front end (e.g., a modulator, a multiplexer, a local oscillator, etc.), is amplified by the selected power amplifier, and the transmitted by the antenna.

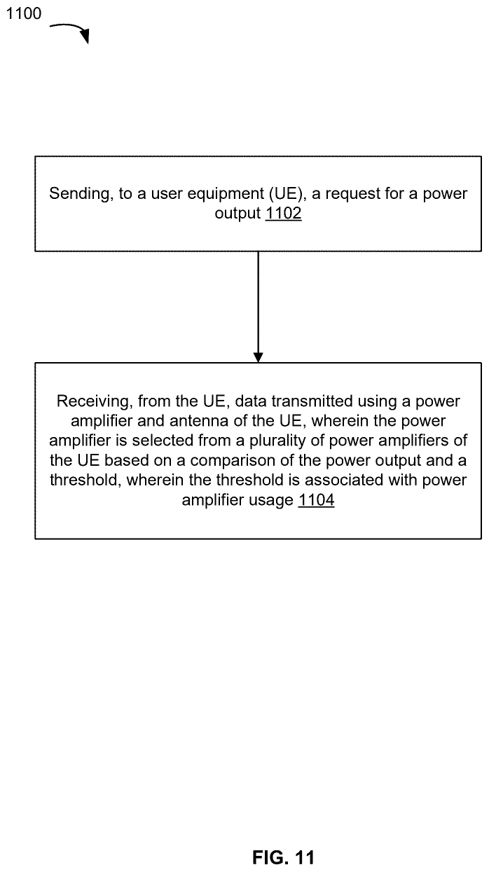

FIG. 11 illustrates another example of an operational flow/algorithmic structure 1100 for an antenna-power amplifier selection, in accordance with some embodiments. The operational flow/algorithmic structure 1100 can be implemented by a base station (or an apparatus of the base station, where the apparatus includes processing circuitry). The base station can be an example of the base station 108 described herein. In some embodiments, the operational flow/algorithmic structure 1100 may be implemented by executing instructions stored in a tangible, non-transitory, computer-readable storage medium, such as a memory of the base station. While the operational flow/algorithmic structure 1100 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1100 includes, at 1102, sending, to a user equipment (UE), a request for a power output. For instance, the request is sent in DCI.

In an example, the operational flow/algorithmic structure 1100 includes, at 1104, receiving, from the UE, data transmitted using a power amplifier and antenna of the UE, wherein the power amplifier is selected from a plurality of power amplifiers of the UE based on a comparison of the power output and a threshold, wherein the threshold is associated with power amplifier usage. For instance, the data is received in a signal, where the signal is amplified by the power amplifier and sent via the antenna. The UE can select the amplifier according to the operational flow/algorithmic structure 1000.

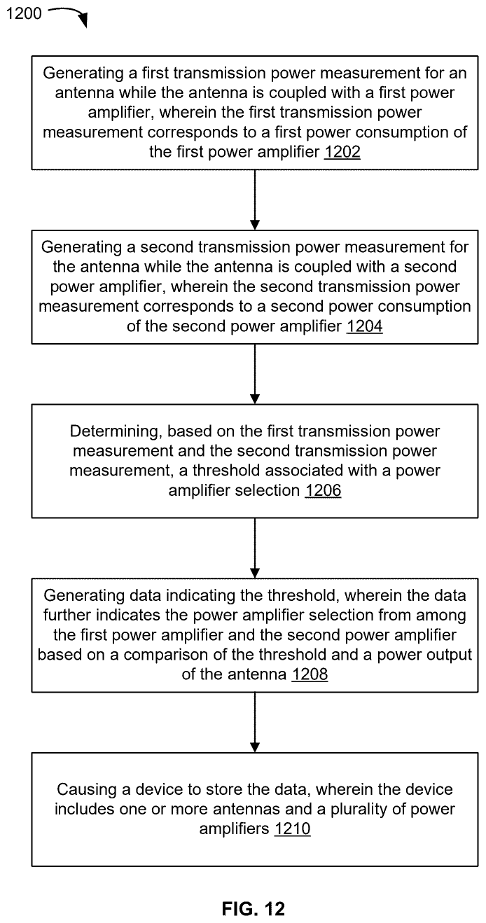

FIG. 12 illustrates an example of an operational flow/algorithmic structure 1200 for UE characterization, in accordance with some embodiments. The operational flow/algorithmic structure 1200 can be implemented by a system (or an apparatus of the system, where the apparatus includes processing circuitry). The system can be an example of the system 606 of FIG. 6. The characterization can be performed using a UE that can be a DUT. In some embodiments, the operational flow/algorithmic structure 1200 may be implemented by executing instructions stored in a tangible, non-transitory, computer-readable storage medium, such as a memory of the system. While the operational flow/algorithmic structure 1200 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1200 includes, at 1202, generating a first transmission power measurement for an antenna while the antenna is coupled with a first power amplifier, wherein the first transmission power measurement corresponds to a first power consumption of the first power amplifier. For instance, given a set of transmission parameters (e.g., particular RAT, frequency band, and frequency bandwidth, in addition to the antenna) and a requested power output, a UE that includes the antenna and the first power amplifier performs an uplink transmission. The current consumption of the first power amplifier used to amplify the signal of the uplink transmission can be measured. The power output of the antenna for the uplink transmission can also be measured. The first transmission power measurement can include the current consumption measurement of the first power amplifier, the requested power, and, optionally, the measured power.

In an example, the operational flow/algorithmic structure 1200 includes, at 1204, generating a second transmission power measurement for the antenna while the antenna is coupled with a second power amplifier, wherein the second transmission power measurement corresponds to a second power consumption of the second power amplifier. For instance, given the same set of transmission parameters (e.g., particular RAT, frequency band, and frequency bandwidth, in addition to the antenna) and the same requested power output, the UE that further incudes the second power amplifier performs another uplink transmission. The current consumption of the second power amplifier used to amplify the signal of the uplink transmission can be measured. The power output of the antenna for the uplink transmission can also be measured. The second transmission power measurement can include the current consumption measurement of the second power amplifier, the requested power, and, optionally, the measured power.

Similar transmission power measurements can be collected for each power amplifier of the UE and per antenna, RAT, frequency band, frequency bandwidth, and per requested power output.

In an example, the operational flow/algorithmic structure 1200 includes, at 1206, determining, based on the first transmission power measurement and the second transmission power measurement, a threshold associated with a power amplifier selection. For instance, these two measurements and, possibly, all other transmission power measurements can be processed to determine switch points, define thresholds, and associate power amplifiers with regions defined by the thresholds, as described in FIG. 6.

In an example, the operational flow/algorithmic structure 1200 includes, at 1208, generating data indicating the threshold, wherein the data further indicates the power amplifier selection from among the first power amplifier and the second power amplifier based on a comparison of the threshold and a power output of the antenna. For instance, the data can be characterization data that can be organized in a LUT. The LUT 700 is an example of such an arrangement.

In an example, the operational flow/algorithmic structure 1200 includes, at 1210, causing a device to store the data, wherein the device includes one or more antennas and a plurality of power amplifiers. For instance, the data is sent OTA to the device (e.g., a UE of the same type as the DUT) after the device is manufactured or stored at the device (e.g., in its memory) as part of its manufacturing. Of course, the characterization can be repeated across multiple DUTs before the final data is caused to be stored at the device.

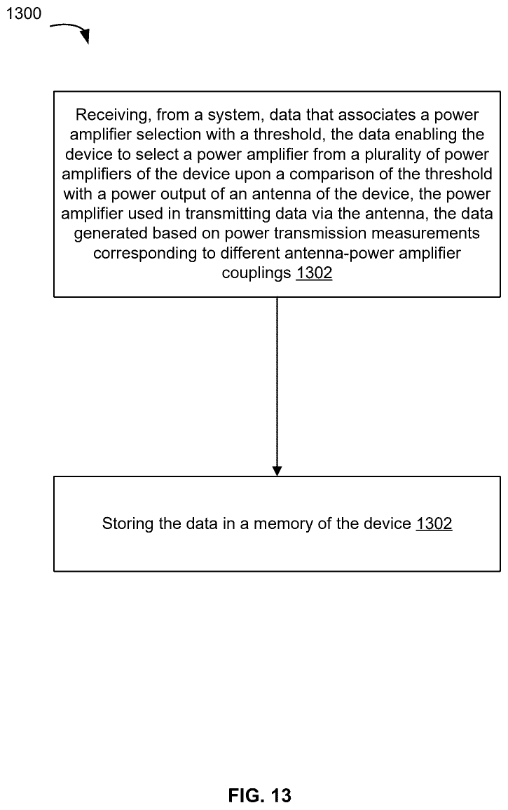

FIG. 13 illustrates an example of an operational flow/algorithmic structure 1300 that can follow a UE characterization, in accordance with some embodiments. The operational flow/algorithmic structure 1300 can be implemented by a device (or an apparatus of the device, where the apparatus includes processing circuitry). The device can be an example of any of the UEs described herein. In some embodiments, the operational flow/algorithmic structure 1300 may be implemented by executing instructions stored in a tangible, non-transitory, computer-readable storage medium, such as a memory of the device. While the operational flow/algorithmic structure 1300 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1300 includes, at 1302, receiving, from a system, data that associates a power amplifier selection with a threshold, the data enabling the device to select a power amplifier from a plurality of power amplifiers of the device upon a comparison of the threshold with a power output of an antenna of the device, the power amplifier used in transmitting data via the antenna, the data generated based on power transmission measurements corresponding to different antenna-power amplifier couplings. The system can be an example of the system 606 of FIG. 6. The data can be characterization data organized in a LUT (e.g., the LUT 700) following a device characterization process that implements the operational flow/algorithmic structure 1200.

In an example, the operational flow/algorithmic structure 1300 includes, at 1304, storing the data in a memory of the device. For instance, the data can be stored in a non-volatile memory of the device and used at runtime to select a power amplifier per the operational flow/algorithmic structure 1000.

The UE 1400 may be similar to and substantially interchangeable with any of the UEs described herein above. Particularly, the UE 1400 can include multiple antennas and power amplifiers, can select an antenna for uplink transmission, and can select a power amplifier to amplify the signal to be sent in the uplink transmission. The power amplifier selection can be based on a set of transmission parameters (e.g., the antenna, RAT, frequency band, and/or frequency bandwidth) and a power output requested for the uplink transmission.

The UE 1400 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE, or an NR-Light UE, or an ambient IoT device.

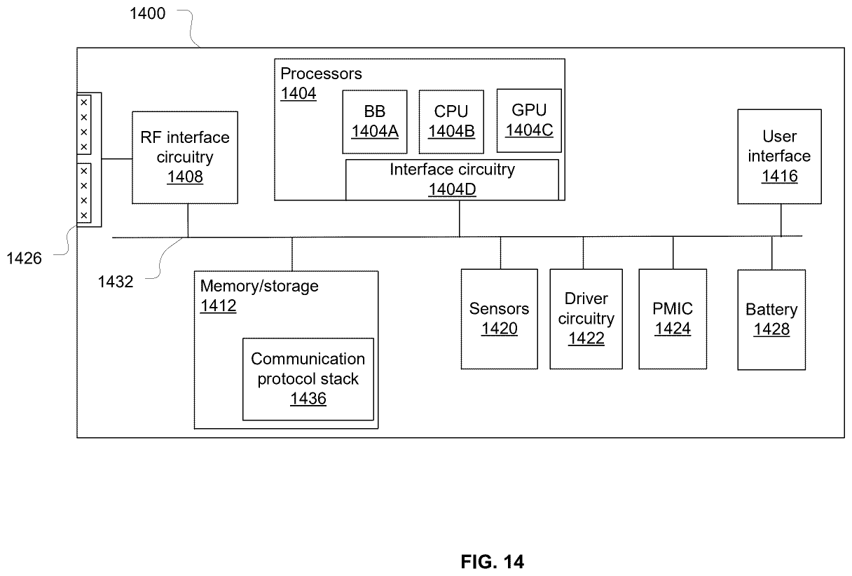

The UE 1400 may include processors 1404, RF interface circuitry 1408, memory/storage 1412, user interface 1416, sensors 1420, driver circuitry 1422, power management integrated circuit (PMIC) 1424, and battery 1428. The processors 1404, or portions thereof, can represent processing circuitry that can be coupled with an RF chain to form an MR or the LP-WUR. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry, such as baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1404A may also access group information from memory/storage 1412 to determine search space groups in which a number of repetitions of a PDCCH may be transmitted.

The memory/storage 1412 may include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1450 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1450.

In various embodiments, the RF interface circuitry 1408 may be configured to transmit/receive signals in a manner compatible with NR access technologies.

The antenna 1450 may include a number of antenna elements that each convert electrical signals into radio waves to travel through the air and to convert received radio waves into electrical signals. The antenna elements may be arranged into one or more antenna panels. The antenna 1450 may have antenna panels that are omnidirectional, directional, or a combination thereof to enable beamforming and multiple input, multiple output communications. The antenna 1450 may include microstrip antennas, printed antennas fabricated on the surface of one or more printed circuit boards, patch antennas, phased array antennas, etc. The antenna 1450 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations, such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

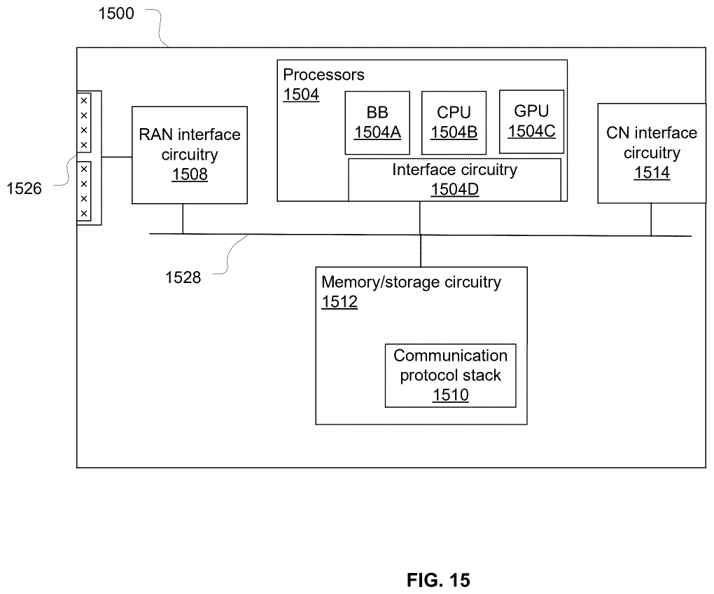

FIG. 15 illustrates a base station 1500, in accordance with some embodiments. The base station 1500 may be similar to and substantially interchangeable with the base station 108 of FIG. 1 and other base stations described herein above. Particularly, the base station 1500 can request a UE to transmit at a particular power output. Based on this request and other factors, the UE can select a power amplifier to amplify an uplink signal such that the request is satisfied.

The base station 1500 may include processors 1504, RAN interface circuitry 1508, core network (CN) interface circuitry 1512, and memory/storage circuitry 1516.

The components of the base station 1500 may be coupled with various other components over one or more interconnects 1528.

The processors 1504, RAN interface circuitry 1508, memory/storage circuitry 1516 (including communication protocol stack 1510), antenna 1550, and interconnects 1528 may be similar to like-named elements shown and described with respect to FIG. 14.

The CN interface circuitry 1512 may provide connectivity to a core network, for example, a Fifth Generation Core network (5GC) using a 5GC-compatible network interface protocol, such as carrier Ethernet protocols, or some other suitable protocol. Network connectivity may be provided to/from the base station 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 16 illustrates a system 1600, in accordance with some embodiments. The system 1600 is an example of the systems described herein above, such as the system 606. For example, the system 1600 can be used in a device characterization process to generate a LUT. The system 1600 can send the LUT to a device for runtime use in selecting a power amplifier.

In an example, the system 1600 can include at least a processor 1602, a memory 1604, input/output peripherals (I/O) 1606, communication peripherals 1608, and a power source 1610. The power source 1610 can include a power storage component and/or an interconnect to an external power source. An interface bus can be configured to communicate, transmit, and transfer data, controls, and commands among the various components of the system 1600. The memory 1604 can include computer-readable storage media, such as RAM; ROM; electrically erasable programmable read-only memory (EEPROM); hard drives; CD-ROMs; optical storage devices; magnetic storage devices; electronic non-volatile computer storage, for example, Flash® memory; and other tangible storage media. Any of such computer readable storage media can be configured to store instructions or program codes embodying aspects of the disclosure. The memory 1604 can also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the system 1600.

Further, the memory 1604 includes an operating system, programs, and applications. The processor 1602 is configured to execute the stored instructions and includes, for example, a logical processing unit, a microprocessor, a digital signal processor, and other processors. The I/O peripherals 1606 can include user interfaces, such as a light source; an alarm device; a keyboard; screen (e.g., a touch screen); microphone; speaker; other input/output devices; and computing components, such as graphical processing units; serial ports; parallel ports; universal serial buses; and other input/output peripherals. The communication peripherals 1608 are configured to facilitate communication between the system 1600 and other systems over a communications network and include, for example, a network interface controller, modem, wireless and wired interface cards, antenna, and other communication peripherals.

### EXAMPLES

In the following sections, further exemplary embodiments are provided.

Example 1 includes a method comprising: processing a request of a base station for a power output; comparing the power output and a threshold associated with power amplifier usage; selecting, based on an outcome of the compare, a power amplifier from a plurality of power amplifiers that are coupled to an antenna; and causing data to be transmitted to the base station by at least using the power amplifier and the antenna.

Example 2 includes a method comprising: processing a request of a base station for a power output; comparing the power output and a threshold associated with power amplifier usage; selecting, based on an outcome of the compare, a power amplifier from a first power amplifier coupled with an antenna and a second power amplifier coupled with an antenna; and causing data to be transmitted to the base station by at least using the power amplifier and the antenna.

Example 3 includes a method comprising: sending, to a user equipment (UE), a request for a power output; and receiving, from the UE, data transmitted using a power amplifier and antenna of the UE, wherein the power amplifier is selected from a plurality of power amplifiers of the UE based on a comparison of the power output and a threshold, wherein the threshold is associated with power amplifier usage.

Example 4 includes the method of any example 1 or 2, further comprising: determining a set of transmission parameters associated with transmitting the data; and determining a value of the threshold based on the set of parameters.

Example 5 includes the method of example 4, wherein the set of transmission parameters includes at least one of: a radio access technology (RAT), a frequency band, a bandwidth, or the antenna.

Example 6 includes the method of example 4, wherein the value is determined based on a look-up of characterization data stored in memory, wherein the characterization data is defined based on an offline characterization process and associates the value with at least a radio access technology (RAT), a frequency band, a bandwidth, and the antenna.

Example 7 includes the method of any preceding example, wherein the threshold corresponds to a power level over which a power amplifier switch is to occur from a first power amplifier to a second power amplifier of the plurality of power amplifiers.

Example 8 includes the method of example 7, wherein the outcome of the compare indicates that the power output is larger than the power level, and wherein the power amplifier is selected as the first power amplifier such that the power amplifier switch is foregone.

Example 9 includes the method of example 7, wherein the outcome of the compare indicates that the power output is smaller than the power level, and wherein the power amplifier is selected as the second power amplifier such that the power amplifier switch is performed.

Example 10 includes the method of any preceding example, further comprising: processing or causing processing of additional power output requests of the base station received during a period of time; and determining or causing determining of the power output as an average of requested power outputs over the period of time.

Example 11 includes the method of any preceding example, further comprising: determining or causing determining of power levels of transmissions via the antenna during a period of time; and determining or causing determining of the power output as an average of the power levels over the period of time.

Example 12 includes the method of any preceding example, wherein the outcome of the compare indicates that the power output is smaller than the threshold, and wherein the power amplifier is selected as a first power amplifier that has a lower power loss than a second power amplifier of the plurality of power amplifiers.

Example 13 includes the method of any preceding example, wherein the outcome of the compare indicates that the power output is smaller than the threshold, and wherein the power amplifier is selected as a first power amplifier that is physically closer than a second power amplifier of the plurality of power amplifiers to the antenna.

Example 14 includes the method of any preceding example, wherein the outcome of the compare indicates that the power output is smaller than the threshold, and wherein the power amplifier is selected as a first power amplifier that has a lower current consumption than a second power amplifier of the plurality of power amplifiers.

Example 15 includes the method of any preceding example, further comprising: determining or causing determining that the first antenna instead of the second antenna is to be used for transmitting the data; and determining or causing determining a value of the threshold based on a look-up of characterization data, the look-up using an identifier of the first antenna, the characterization data associating the value with a set of transmission parameters.

Example 16 includes the method of example 15, further comprising: determining or causing determining of a frequency band to use for the transmitting of the data, wherein the look-up further uses an identifier of the frequency band.

Example 17 includes the method of example 15, further comprising: determining or causing determining of a frequency bandwidth to use for the transmitting of the data, wherein the look-up further uses a value of the frequency bandwidth.

Example 18 includes the method of example 15, further comprising: determining or causing determining of a radio access technology (RAT) to use for the transmitting of the data, wherein the look-up further uses an identifier of the RAT.

Example 19 includes the method of any preceding example, further comprising: storing or causing storing of characterization data that associates the threshold with a set of transmission parameters, wherein the characterization data indicates, for one or more values of the set of transmission parameters, a value of the threshold.

Example 20 includes the method of example 19, wherein the characterization data further indicates, for the one or more values of the set of transmission parameters, which of the first power amplifier and the second power amplifier is to be used if the power output is larger than the value of the threshold and which of the first power amplifier and the second power amplifier is to be used if the power output is smaller than the value of the threshold.

Example 21 includes a method comprising: generating a first transmission power measurement for an antenna while the antenna is coupled with a first power amplifier, wherein the first transmission power measurement corresponds to a first power consumption of the first power amplifier; generating a second transmission power measurement for the antenna while the antenna is coupled with a second power amplifier, wherein the second transmission power measurement corresponds to a second power consumption of the second power amplifier; determining, based on the first transmission power measurement and the second transmission power measurement, a threshold associated with a power amplifier selection; generating data indicating the threshold, wherein the data further indicates the power amplifier selection from among the first power amplifier and the second power amplifier based on a comparison of the threshold and a power output of the antenna; and causing a device to store the data, wherein the device includes one or more antennas and a plurality of power amplifiers.

Example 22 includes a method comprising: generating a first transmission power measurement for an antenna while the antenna is coupled with a first power amplifier, wherein the first transmission power measurement corresponds to a first power consumption of the first power amplifier; generating a second transmission power measurement for the antenna while the antenna is coupled with a second power amplifier, wherein the second transmission power measurement corresponds to a second power consumption of the second power amplifier; determining, based on the first transmission power measurement and the second transmission power measurement, a threshold associated with a power amplifier selection; and generating data indicating the threshold, wherein the data further indicates the power amplifier selection from among the first power amplifier and the second power amplifier based on a comparison of the threshold and a power output of the antenna.

Example 23 includes a method implemented comprising: receiving, from a system, data that associates a power amplifier selection with a threshold, the data enabling the device to select a power amplifier from a plurality of power amplifiers of a device upon a comparison of the threshold with a power output of an antenna of the device, the power amplifier used in transmitting data via the antenna, the data generated based on power transmission measurements corresponding to different antenna-power amplifier couplings; and storing the data in a memory of the device.

Example 24 includes the method of any preceding example 21-23, wherein the first transmission power measurement is generated by using a device under test (DUT), wherein the data is generated for a type of devices that corresponds to the DUT and the device.

Example 25 includes the method of any preceding example 21-24, wherein the first transmission power measurement is generated by at least using a set of transmission parameters, wherein the data associates the set of transmission parameters with the threshold.

Example 26 includes the method of example 25, wherein the second transmission power measurement is generated by at least also using the set of transmission parameters.

Example 27 includes the method of example 25, wherein the set of transmission parameters includes at least one of: a radio access technology (RAT), a frequency band, a bandwidth, or the antenna.

Example 28 includes the method of example 27, wherein the data indicates, for one or more values of the set of transmission parameters, a value of the threshold.

Example 29 includes the method of example 28, wherein data further indicates, for one or more values of the set of transmission parameters, which of the first power amplifier and the second power amplifier is to be used for a data transmission if the power output is larger than the value of the threshold and which of the first power amplifier and the second power amplifier is to be used for the data transmission if the power output is smaller than the value of the threshold.

Example 30 includes the method of any preceding example 21-29, wherein the data is generated as a look-up table (LUT), wherein the LUT associates a value of the threshold with a frequency band usable in a data transmission.

Example 31 includes the method of example 30, wherein the LUT further associates the value of the threshold with a frequency bandwidth usable in the data transmission.

Example 32 includes the method of example 30, wherein the LUT further associates the value of the threshold with an identifier of the antenna.

Example 33 includes the method of example 30, wherein the LUT further associates the value of the threshold with a radio access technology.

Example 34 includes the method of example 30, wherein the LUT indicates whether the first power amplifier or the second power amplifier is to be used upon a comparison of the power output and the value of the threshold.

Example 35 includes the method of any preceding example 21-34, wherein the data is generated as a look-up table (LUT), wherein the LUT indicates, for a same frequency band but for two different frequency bandwidths, at least one of: a different value for the threshold or a different power amplifier selection.

Example 36 includes the method of any preceding example 21-35, wherein the data is generated as a look-up table (LUT), wherein the LUT indicates, for two different frequency bands, at least one of: a different value for the threshold or a different power amplifier selection.

Example 37 includes the method of any example 21-22, wherein the antenna is a first antenna, and further comprising: generating a third transmission power measurement for a second antenna while the second antenna is coupled with a first power amplifier; and generating a fourth transmission power measurement for the second antenna while the second antenna is coupled with a second power amplifier, wherein the data associates a first value of the threshold with the first antenna and a second value of the threshold with the second antenna.

Example 38 includes the method of any preceding example 21-37, wherein the data indicates that the first power amplifier is to be selected upon the power output being smaller than the threshold, and wherein the first power amplifier has a lower power loss than the second power amplifier.

Example 39 includes the method of any preceding example 21-38, wherein the data indicates that the first power amplifier is to be selected upon the power output being smaller than the threshold, and wherein the first power amplifier is physically closer than the second power amplifier to the antenna.

Example 40 includes the method of any preceding example 21-39, wherein the data indicates that the first power amplifier is to be selected upon the power output being smaller than the threshold, and wherein the first power amplifier has a lower current consumption than the second power amplifier.

Example 41 includes a user equipment (UE) or an apparatus comprising: one or more processors; and one or more memory storing instructions that, upon execution by the one or more processors, configure the UE or the apparatus to perform a method described in or related to any of the preceding examples.

Example 42 includes one or more computer-readable media storing instructions that, when executed on a user equipment (UE) or an apparatus, cause the UE or the apparatus to perform operations comprising one or more elements of a method described in or related to any of the preceding examples.

Example 43 includes an apparatus comprising means to perform one or more elements of a method described in or related to any of the preceding examples.

Example 44 includes one or more non-transitory computer-readable media comprising instructions to cause an apparatus, upon execution of the instructions by one or more processors of the apparatus, to perform one or more elements of a method described in or related to any of the preceding examples.

Example 45 includes an apparatus comprising logic, modules, or processing circuitry configured to perform one or more elements of a method described in or related to any of the preceding examples.

Example 46 includes an apparatus, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Applicant hereby claims:

1. An apparatus comprising:
processing circuitry configured to:
process a request of a base station for a power output;
compare the power output and a threshold associated with power amplifier usage;
select, based on an outcome of the compare, a power amplifier from a plurality of power amplifiers that are coupled to an antenna; and
cause data to be transmitted to the base station by at least using the power amplifier and the antenna.

2. The apparatus of claim 1, wherein the processing circuitry is further configured to:
determine a set of transmission parameters associated with transmitting the data; and
determine a value of the threshold based on the set of parameters.

3. The apparatus of claim 2, wherein the set of transmission parameters includes at least one of: a radio access technology (RAT), a frequency band, a bandwidth, or the antenna.

4. The apparatus of claim 2, wherein the value is determined based on a look-up of characterization data stored in memory, wherein the characterization data is defined based on an offline characterization process and associates the value with at least a radio access technology (RAT), a frequency band, a bandwidth, and the antenna.

5. The apparatus of claim 1, wherein the threshold corresponds to a power level over which a power amplifier switch is to occur from a first power amplifier to a second power amplifier of the plurality of power amplifiers.

6. The apparatus of claim 5, wherein the outcome of the compare indicates that the power output is larger than the power level, and wherein the power amplifier is selected as the first power amplifier such that the power amplifier switch is foregone.

7. The apparatus of claim 5, wherein the outcome of the compare indicates that the power output is smaller than the power level, and wherein the power amplifier is selected as the second power amplifier such that the power amplifier switch is performed.

8. The apparatus of claim 1, wherein the processing circuitry is further configured to:
process additional power output requests of the base station received during a period of time; and
determine the power output as an average of requested power outputs over the period of time.

9. The apparatus of claim 1, wherein the processing circuitry is further configured to:
determine power levels of transmissions via the antenna during a period of time; and
determine the power output as an average of the power levels over the period of time.

10. The apparatus of claim 1, wherein the outcome of the compare indicates that the power output is smaller than the threshold, and wherein the power amplifier is selected as a first power amplifier that has a lower power loss than a second power amplifier of the plurality of power amplifiers.

11. The apparatus of claim 1, wherein the outcome of the compare indicates that the power output is smaller than the threshold, and wherein the power amplifier is selected as a first power amplifier that is physically closer than a second power amplifier of the plurality of power amplifiers to the antenna.

12. The apparatus of claim 1, wherein the outcome of the compare indicates that the power output is smaller than the threshold, and wherein the power amplifier is selected as a first power amplifier that has a lower current consumption than a second power amplifier of the plurality of power amplifiers.

13. A device comprising:
an antenna;
a first power amplifier coupled with the antenna;
a second power amplifier coupled with the antenna; and
processing circuitry configured to:
process a request of a base station for a power output;
compare the power output and a threshold associated with power amplifier usage;
select, based on an outcome of the compare, a power amplifier from the first power amplifier and the second power amplifier; and
cause data to be transmitted to the base station by at least using the power amplifier and the antenna.

14. The device of claim 13, wherein the antenna is a first antenna, and wherein the device further comprises:
a second antenna coupled with the first power amplifier and the second power amplifier,
wherein the processing circuitry is further configured to:
determine that the first antenna instead of the second antenna is to be used for transmitting the data; and
determine a value of the threshold based on a look-up of characterization data, the look-up using an identifier of the first antenna, the characterization data associating the value with a set of transmission parameters.

15. The device of claim 14, wherein the processing circuitry is further configured to:
determine a frequency band to use for the transmitting of the data, wherein the look-up further uses an identifier of the frequency band.

16. The device of claim 14, wherein the processing circuitry is further configured to:
determine a frequency bandwidth to use for the transmitting of the data, wherein the look-up further uses a value of the frequency bandwidth.

17. The device of claim 14, wherein the processing circuitry is further configured to:
determine a radio access technology (RAT) to use for the transmitting of the data, wherein the look-up further uses an identifier of the RAT.

18. The device of claim 13, wherein the processing circuitry is further configured to:
store characterization data that associates the threshold with a set of transmission parameters, wherein the characterization data indicates, for one or more values of the set of transmission parameters, a value of the threshold.

19. The device of claim 18, wherein the characterization data further indicates, for the one or more values of the set of transmission parameters, which of the first power amplifier and the second power amplifier is to be used if the power output is larger than the value of the threshold and which of the first power amplifier and the second power amplifier is to be used if the power output is smaller than the value of the threshold.

20. A method comprising:
sending, to a user equipment (UE), a request for a power output; and
receiving, from the UE, data transmitted using a power amplifier and antenna of the UE, wherein the power amplifier is selected from a plurality of power amplifiers of the UE based on a comparison of the power output and a threshold, wherein the threshold is associated with power amplifier usage.
